(19) United States
(12) Patent Application Publication
(10) Pub. No.: US 2002/0090450 A1
(43) Pub. Date: Jul. 11, 2002

(54) Method for fabricating a precious-metal electrode

(76) Inventors: Walter Hartner, Glen Allen, VA (US); Frank Hintermaier, Munchen (DE); Gunther Schindler, Munchen (DE)

Correspondence Address: LERNER AND GREENBERG, P.A., Post Office Box 2480, Hollywood, FL, 33022-2480, US

(21) Appl. No.: 10/027,533

(22) Filed: Dec. 26, 2001

Related U.S. Application Data
(63) Continuation of application No. PCT/DE00/02033, filed on Jun. 23, 2000.

(30) Foreign Application Priority Data
Jun. 25, 1999 (DE) 199 29 306.6

(51) Int. Cl. B05D 5/12

(52) U.S. Cl. 427/79; 427/81; 427/282

(57) ABSTRACT

A method for fabricating a precious-metal electrode for a storage capacitor includes providing a substrate, applying a catalytically inactive insulation and a catalytically active connection region to the substrate. The catalytically active connection region can be a precious metal material such as a precious metal or an oxide of a precious metal. The catalytically active connection region and the catalytically inactive insulation region are produced, for example, by patterning the connection region or by planarizing the connection region and the insulation region. The next step is depositing selectively the precious metal material on the catalytically active connection region by passing an organometallic compound of a precious metal to the substrate at a temperature from 0° to 120° C. Alternatively, the precious metal can be formed by depositing selectively the precious metal material on the catalytically active connection region by passing Pt(PF₃)₄ to the substrate at a temperature from 80° to 150° C.

### CROSS-REFERENCE TO RELATED APPLICATION

This application is a continuation of copending International Application PCT/DE00/02033, filed Jun. 23, 2000, which designated the United States.

### BACKGROUND OF THE INVENTION

Field of the Invention

The invention relates to a method for fabricating a precious-metal electrode, in particular for a storage capacitor of a memory cell.

Over the course of the last twenty-five years, the storage density of DRAM memory modules has in each case quadrupled from one generation to the next. However, the basic configuration of an elemental memory cell and the materials used to construct the memory cell have remained substantially unchanged. A DRAM memory cell includes a transistor and a capacitor that stores the charge required to represent the information, just as it did twenty-five years ago. The capacitor of the memory cell has electrodes made from doped silicon or polysilicon and a dielectric layer of silicon dioxide and/or silicon nitride disposed between the electrodes.

To be able to reproducibly read the charge stored in a capacitor, the capacitance of the capacitor should be at least approximately 30 fF. At the same time, it has been necessary, and remains necessary, to reduce the lateral extent of the capacitor, in order to increase the storage density. These inherently contradictory demands imposed on the capacitor of the memory cell have led and continue to lead to increasingly complex structuring of the capacitor (“trench capacitors”, “stack capacitors”, “crown-shaped capacitors”), in order to be able to provide a sufficiently large capacitor surface despite the lateral extent of the capacitor becoming ever smaller. However, this makes fabrication of the capacitor increasingly complex and therefore increasingly expensive.

A further way of achieving a sufficient capacitance of the capacitor is to use different materials between the capacitor electrodes. Therefore, new materials, in particular high-ε paraelectrics and ferroelectrics, have recently been used between the capacitor electrodes of a memory cell instead of the conventional silicon oxide/silicon nitride. These new materials have a considerably higher relative dielectric constant (>20) than the conventional silicon oxide/silicon nitride (<8). Therefore, the use of these materials, for the same capacitance and the same lateral extent of the memory cell, allows the capacitor area required and therefore the complexity of patterning of the capacitor required, to be reduced considerably. By way of example, barium strontium titanate (BST, (Ba, Sr)TiO₃), lead zirconate titanate (PZT, Pb(Zr, Ti)O₃) or lanthanum-doped lead zirconate titanate, or strontium bismuth tantalate (SBT, SrBi₂Ta₂O₉) are used.

In addition to conventional DRAM memory modules, ferroelectric memory configurations, known as FRAMs, will play an important role in the future. Compared to conventional memory configurations, such as for example DRAMs and SRAMs, ferroelectric memory configuration have the advantage that the stored information is not lost even if the voltage or current supply is interrupted, but rather it remains stored. This nonvolatile state of ferroelectric memory configuration is based on the fact that, when using ferroelectric materials, the polarization that is applied by an external electric field is substantially retained even after the external electric field has been disconnected. The abovementioned new materials, such as barium strontium titanate (BST, (Ba, Sr)TiO₃), lead zirconate titanate (PZT, Pb(Zr, Ti)O₃) or lanthanum-doped lead zirconate titanate, or strontium bismuth tantalate (SBT, SrBi₂Ta₂O₉) are also used for ferroelectric memory configurations.

Unfortunately, the use of the new paraelectrics or ferroelectrics also requires the use of new electrode materials. The new paraelectrics or ferroelectrics are usually deposited on electrodes that are already present (bottom electrodes). The processing takes place at high temperatures, at which the materials of which the capacitor electrodes normally includes, for example doped polysilicon, are readily oxidized and lose their electrically conductive properties, which would lead to the memory cell failing.

4d and 5d transition metals are promising candidates that could replace doped silicon/polysilicon as electrode material because they have good resistance to oxidation and/or form electrically conductive oxides. The following members of 4d and 5d transition metals are particularly good candidates: precious metals such as Ru, Rh, Pd, Os, Ir, and in particular platinum.

Unfortunately, the abovementioned materials, which have only recently been developed, are very difficult or even impossible to etch chemically. The material that is removed by etching, even when using “reactive” gases, is attributable predominately or almost exclusively to the physical component of the etching.

Patterning of the materials used hitherto has generally been accomplished by plasma-assisted anisotropic etching methods. In this case, physical-chemical methods are generally employed. In such physical-chemical methods, gas mixtures include one or more reactive gases and inert gases. Examples of reactive gases include oxygen, chlorine, bromine, hydrogen chloride, hydrogen bromide, or halogenated hydrocarbons. Inert gases include Argon (Ar) and Helium (He). These gas mixtures are generally excited in an alternating electromagnetic field at low pressures, with the result that the gas mixture is converted into a plasma.

The positive ions of the plasma then impinge virtually perpendicularly on the layer that is to be patterned. This impingement encourages reproduction of a mask resting on the layer that is to be patterned. Photoresists are usually used as mask materials, since they can be patterned relatively easily by an exposure step and a development step. The physical component of the etching is effected by pulsed and kinetic energy of the impinging ions (e.g. Cl₂⁺, Ar⁺). In addition, in this way, chemical reactions between the layer that is to be patterned and the reactive gas particles (ions, molecules, atoms, radicals) leading to the formation of volatile reaction products, are initiated or enhanced (chemical component of the etching). These chemical reactions between the substrate particles and the gas particles are responsible for high etching selectivities of the etching process.

Because the chemical component is small or even absent when etching the above materials, in particular when etching the electrode material, the amount of material removed from the layer to be patterned by etching is of the same order of magnitude as the amount of material removed by etching from the mask or the underlying layer (etching stop layer), i.e. the etching selectivity with respect to the etching mask or underlying layer is generally low (between approximately 0.3 and 3.0). Consequently, the erosion of masks with inclined flanks and the inevitable formation of bevels on the masks means that it is only possible to ensure a low dimensional accuracy of the patterning. Furthermore, particularly when carrying out an overetching step, the underlying layer is etched to a considerable extent, and the result is sloping etched flanks that are very difficult to control. Consequently, very small electrodes (basic surface area of the electrode=F², F=smallest feature size which can be fabricated using a defined technique) can only be produced with very considerable outlay.

Some have attempted to deposit precious metals on a substrate in lithographically defined regions or with prestructured masks, in order to avoid the problematical etching of the precious metals. A method of this type is described, for example, in U.S. Pat. No. 5,789,320 to Andricacos et al.

### SUMMARY OF THE INVENTION

It is accordingly an object of the invention to provide a method for fabricating a precious-metal electrode that overcomes the hereinafore-mentioned disadvantages of the heretofore-known methods of this general type and that fabricates a precious-metal electrode for a storage capacitor in which the above-mentioned problems are considerably reduced or avoided altogether.

With the foregoing and other objects in view, there is provided, in accordance with the invention, a method for fabricating a precious-metal electrode for a storage capacitor. The method includes providing a substrate, applying a catalytically inactive insulation to the substrate, and applying a catalytically active connection region to the substrate. The catalytically active connection region is a precious metal material: for example, a precious metal and/or an oxide of a precious metal. The next step is producing the catalytically active connection region and the catalytically inactive insulation region, for example, by patterning the connection region or planarizing the connection region and the insulation region. The next step is depositing selectively the precious metal material on the catalytically active connection region by passing an organometallic compound of a precious metal to the substrate at a temperature from 0° to 120° C.

With the objects of the invention in view, there is also provided a method for fabricating a precious-metal electrode for a storage capacitor. The method includes providing a substrate, applying a catalytically active connection region to the substrate, and applying a catalytically inactive insulation region to the substrate. The catalytically active connection region is a precious metal material: for example, a precious metal and/or an oxide of a precious metal. The next step is producing a catalytically active connection region and a catalytically inactive insulation region, for example, by patterning the connection region or by planarizing the connection region and the insulation region. The next step is depositing selectively the precious metal material on the catalytically active connection region by passing Pt(PF₃)₄ to the substrate at a temperature of from 80° to 150° C.

The invention provides a method for fabricating a precious-metal electrode for a storage capacitor that includes the following steps:

a) a substrate having at least one catalytically active connection region and at least one catalytically inactive insulation region is provided, the catalytically active connection region being formed from a precious metal or a conductive oxide of a precious metal;

b) at least one organometallic compound of a precious metal is passed to the substrate at a temperature from 0° to 120° C., so that the precious metal is selectively deposited on the catalytically active connection region and the precious-metal electrode is formed.

Furthermore, the invention provides a method for fabricating a precious-metal electrode for a storage capacitor that includes the following steps:

a) a substrate having at least one catalytically active connection region and at least one catalytically inactive insulation region is provided, the catalytically active connection region being formed from a precious metal or a conductive oxide of a precious metal;

b) Pt(PF₃) ₄ is passed to the substrate at a temperature from 80° to 150° C., so that the precious metal is selectively deposited on the catalytically active connection region and the precious-metal electrode is formed.

The methods according to the invention have the advantage that the precious-metal layers, which can only be etched with difficulty, do not have to be patterned directly. The desired structure of the precious-metal electrode is predetermined by the preliminary structuring of the substrate into a catalytically active connection region and a catalytically inactive insulation region and is produced by the selective deposition of the precious metal on the connection region. The invention makes use of the fact that organometallic precious-metal compounds, for example Pt(PF₃)₄ (tetrakis(trifluorophosphane)platinum) readily decomposes on catalytically active surfaces. The decomposition leads to deposition of the precious metal on the catalytically active surfaces. On catalytically inactive surfaces, the decomposition of organometallic precious-metal compounds or Pt(PF₃) ₄ is greatly inhibited at the abovementioned temperatures, so that overall the deposition of the precious metal on the connection region is selective. In this way, direct etching of the precious-metal layer with all the abovementioned problems can be avoided.

Accordingly, the catalytically active and inactive surfaces differ to the extent that, under predetermined process conditions that are identical for both surfaces, precious metal is deposited on the catalytically active surface, while precious-metal deposition on the catalytically inactive surface is substantially not observed. The situation is reinforced by the fact that precious metal that has already been deposited often has an autocatalytic effect on the (organometallic) precious-metal compound.

Methods for the deposition of precious metals are known, for example, from T. Koda et al.: “The Chemistry of Metal CVD”, VCH-Weinheim (1994), pp 329-335, and Z. Xue et al.: “Organometallic Chemical Vapor Deposition of Platinum”, Chem. Mater. (1992), pp 162-166, the content of disclosure of which is hereby incorporated in its entirety.

Furthermore, the method according to the invention for the fabrication of a precious-metal electrode has the advantage that the electrode can be selected to be as small as its connection. For example, if the connection for the electrode of a stack capacitor, usually a plug with a barrier, is fabricated in the smallest feature size F² that it is possible to fabricate with the conventional fabrication methods, the basic surface area of the electrode must be considerably larger than F², in order to be able to ensure an overlap between the electrode and the barrier. If, with the conventional fabrication methods, the basic surface area of the electrode were not selected to be considerably larger than F², inaccuracies in the alignment of the corresponding masks could prevent overlapping between the electrode and the barrier. This would disconnect the electrode, causing the memory cell to fail. Inaccuracies in the alignment of the corresponding masks can also lead to the electrode no longer completely covering the barrier. Consequently, the storage dielectric, for example SBT, can contact the barrier, which generally deteriorates the properties of the storage dielectric. Accordingly; memory cells in which a stack capacitor is used consume relatively large amounts of space, which reduces the maximum storage density.

In the method according to the invention, the connections can be used as catalytically active connection regions and the insulating layer between the connections can be used as catalytically inactive insulation regions. Accordingly, the electrodes are formed in a self-aligned manner on the connections, so that a sufficient overlap between the electrodes and their connections is automatically ensured. There is no need to undesirably enlarge the electrode, as is required in accordance with the prior art, in order to compensate for positioning errors. Accordingly, the space required by the electrode can be reduced. Furthermore, connections made from precious metal or precious metal oxide have a barrier action, which is particularly advantageous for a storage capacitor with a high-ε dielectric.

Because preliminary structuring of the substrate defines the structure of the precious-metal electrode and is used for fabrication of the connections, one mask level can be saved. The different masks that are used in the prior art for production of the connections and for production of the electrodes can be combined to form a single mask, so that fabrication costs can be reduced considerably.

Furthermore, the methods according to the invention have the advantage that the selectively deposited precious metal grows epitaxially and in substantially monocrystalline form. This has the advantage that, during the production of the dielectric or ferroelectric layer that subsequently takes place, it is possible to avoid diffusion of oxygen atoms or, for example, bismuth atoms through the precious metal.

According to a preferred embodiment, step b) is carried out at a temperature of from 20° to 80° C., preferably at a temperature from 40° to 70° C., or at a temperature from 100° to 120° C. (Pt(PF₃)₄. Particularly preferred embodiments of the organometallic compound of a precious metal include Pt(CO)₂Cl₂ (dicarbonyl(dichloro)platinum), Cp*PtMe₂ ((pentamethylcyclopentadienyl)dimethyl platinum), or CpPtMe₃ ((cyclopentadienyl)trimethyl platinum).

According to a preferred embodiment, in step b) at least one reducing agent, preferably hydrogen (H₂), is used.

According to a further preferred embodiment, step b) is conducted at a pressure from 10⁻⁴ to 10 bar, preferably 10⁻³ to 10⁻¹ bar.

According to a further preferred embodiment, the catalytically inactive insulation region contains SiO₂, Si₃N₄, Al₂O₃, AlN, BN, MgO, La₂O₃, LaN, Y₂O₃, YN, Sc₂O₃, ScN, TiO₂, Ta₂O₃ or oxides of the lanthanides. Furthermore, the catalytically active connection region preferably contains rhodium, iridium, ruthenium, osmium, rhenium or the conductive oxides thereof. These precious metals can be sufficiently oxidized to enable them to be patterned using a CMP (chemical mechanical polishing) method.

Furthermore, the precious metal for the precious-metal electrode preferably is platinum, palladium, rhodium, iridium, ruthenium, osmium, or rhenium.

According to a further preferred embodiment, in step a) the following steps are completed in order to provide the substrate having at least one catalytically active connection region and at least one catalytically inactive insulation region:

a substrate having an insulation region is provided;

the material of the catalytically active connection region is applied; and

the catalytically active material of the connection region is patterned, and at least one catalytically active connection region and at least one catalytically inactive insulation region are produced.

The patterning of the material of the connection region may take place by a photographic technique with subsequent etching or by a damascene technique.

According to a further preferred embodiment, in step a) the following steps are completed in order to provide the substrate having at least one catalytically active connection region and at least one catalytically inactive insulation region:

a substrate is provided;

the material of the catalytically active connection region is applied;

the catalytically active material of the connection region is patterned;

the material of the catalytically inactive insulation region is applied; and

a planarization step is carried out, so that at least one catalytically active connection region and at least one catalytically inactive insulation region are produced.

In this case, it is particularly preferred if the material of the connection region is deposited as a layer and the material of the connection region is patterned using a hard mask. Preferred materials for the hard mask are titanium nitride, titanium oxide or silicon oxide. The use of a hard mask generally results in rounded edges during the patterning of the material of the connection region. This leads to the structures produced in this way having a smaller lateral extent on their top side than on their underside. If the area around these structures is then filled with the material of the insulation region, connection regions with a lateral extent which is smaller than that which could be produced directly with the lithography method employed are the result.

According to a further preferred embodiment, the material of the catalytically inactive insulation region is also deposited as a layer. In this case, it is particularly preferable if a CMP step is carried out as the planarization step.

Other features which are considered as characteristic for the invention are set forth in the appended claims.

Although the invention is illustrated and described herein as embodied in a method for fabricating a precious-metal electrode, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIGS. 1 to 5 are fragmentary, diagrammatic sectional views showing the steps of a first method for fabricating precious-metal electrodes;

FIGS. 6 and 7 are fragmentary sectional views showing a second method for fabricating precious-metal electrodes;

FIGS. 8 to 12 are fragmentary sectional views showing a third method for fabricating precious-metal electrodes; and

FIG. 13 is a fragmentary sectional view of a further embodiment of a precious-metal electrode.

### DESCRIPTION OF THE PREFERRED EMBODIMENTS

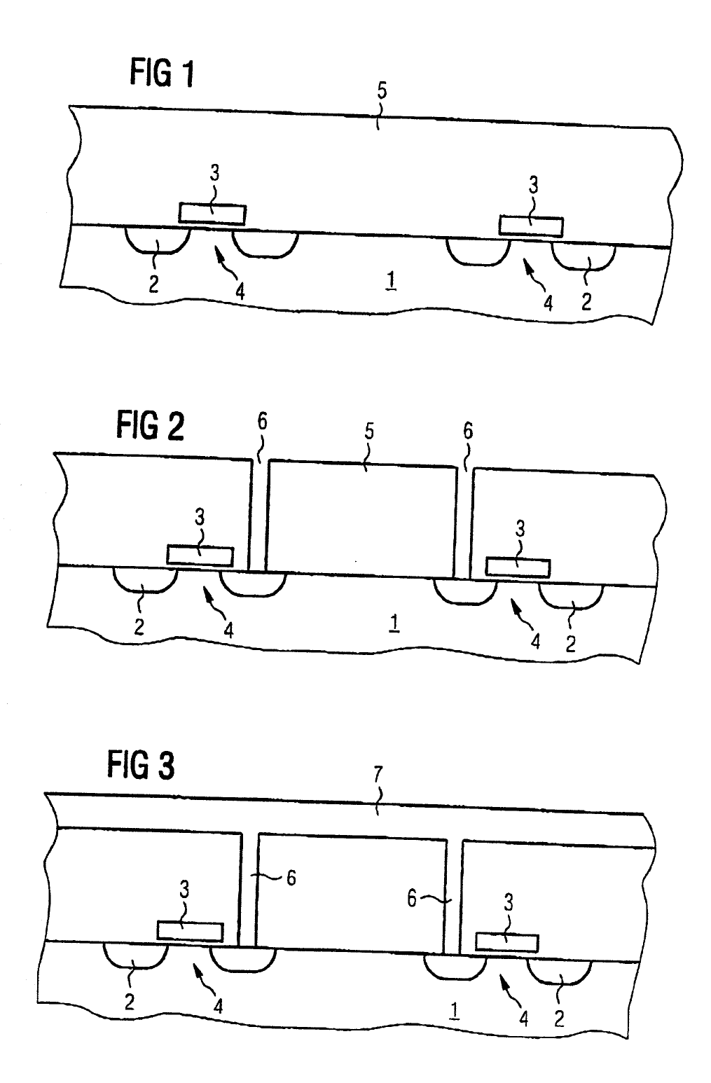

Referring now to the figures of the drawings in detail and first, particularly to FIG. 1 thereof, there is shown a silicon substrate 1 with select transistors 4 which have already been produced. The select transistors 4 each have two diffusion regions 2 that are disposed on the surface of the silicon substrate 1. The channel zone, which is separated from the gate electrode 3 on the surface of the silicon substrate 1 by the gate oxide, is disposed between the diffusion regions 2 of a select transistor 4. These select transistors are fabricated using the methods that are known in the prior art and are not explained in more detail in the present description. An insulating layer 5, for example a SiO₂ layer, is applied to the silicon substrate with the select transistors 4. Depending on the method used for the fabrication of the select transistors 4, it is also possible for a plurality of insulating layers to be applied. The resulting structure is shown in FIG. 1.

Then, a photographic technique is used to produce the contact holes 6. This is completed, for example, by anisotropic etching using fluorine-containing gases. The resulting structure is shown in FIG. 2.

Then, a conductive material 7, for example polysilicon doped in situ, is applied to the structure. This can take place, for example, by a CVD method. The application of the conductive material 7 causes the contact holes 6 to be filled completely, and a cohesive conductive layer is formed on the top side of the silicon substrate 1 (FIG. 3). A CMP (Chemical Mechanical Polishing) step then follows, which removes the cohesive conductive layer at the top side of the silicon substrate 1 and produces a planar surface.

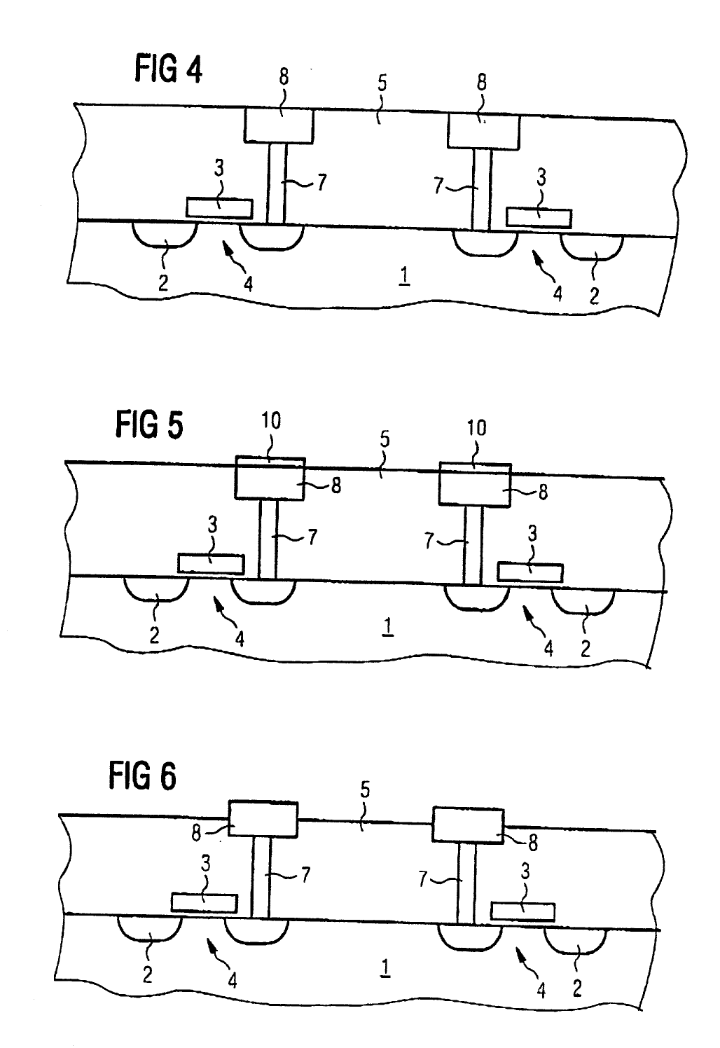

Next, recesses are formed in the insulating layer 5, overlapping the contact holes 6. These recesses are then filled with barrier material 8, for example iridiumoxide. This is achieved by depositing the barrier material 8 over the entire surface and then carrying out a further CMP step. The resulting structure is shown in FIG. 4.

The first step a) of the method according to the invention is then concluded. A substrate having catalytically active connection regions, the barriers 8, and a catalytically inactive insulation region, the insulating layer 5, has been provided.

The selective deposition of the electrode material, for example platinum, follows. For this purpose, the volatile organometallic compound CpPt(Me)₃ in gaseous form is passed onto the prestructured substrate at a pressure of 10⁻² bar and a temperature of 70° C. The catalytic action of the iridium oxide in the connection regions causes the organometallic compound CpPt(Me)₃ to decompose at the surface of the connection regions, where platinum is deposited. Because the surface of the insulating layer 5 is catalytically inactive with regard to the organometallic compound CpPt(Me)₃, there is no decomposition of the organometallic compound CpPt(Me)₃ on the surface of the insulation region under the cited conditions (pressure and temperature), so that no platinum is deposited on the insulation region.

As an alternative, the volatile organometallic compound Pt(CO)₂Cl₂ in gaseous form, together with hydrogen H₂ as reduction gas, also may be passed onto the prestructured substrate at a pressure of 10⁻² bar and a temperature of 70° C. The catalytic action of the iridium oxide in the connection regions also causes the organometallic compound Pt(CO)₂Cl₂ to decompose at the surface of the connection regions, where platinum is deposited. Because the surface of the insulating layer 5 is also catalytically inactive with regard to the organometallic compound pt(co)₂Cl₂, there is no decomposition of the organometallic compound Pt(CO)₂Cl₂ at the surface of the insulation region under the cited conditions (pressure and temperature), so that no platinum is deposited on the insulation region.

The platinum that has been selectively deposited in this way grows epitaxially and substantially in monocrystalline form. This has the advantage that during the production of the dielectric or ferroelectric layer that is subsequently completed, diffusion of oxygen atoms or, for example, bismuth atoms through the electrode 10 to the barrier layer 8 can be avoided. Diffusion of this type generally takes place along grain boundaries, which on account of the monocrystalline growth of the electrode 10 are present substantially only at the edge of the crystal.

The selective deposition of platinum on the barriers 8 enables self-aligned platinum structures with a lateral dimension of less than 0.1 mm to be produced without an additional etching step. The resulting structure is shown in FIG. 5.

The production of a dielectric and/or ferroelectric layer and the deposition of a further layer in order to form the upper electrode (not shown) follows. These layers are usually then patterned together, so that the memory cells including a select transistor 4 and a capacitor are completed.

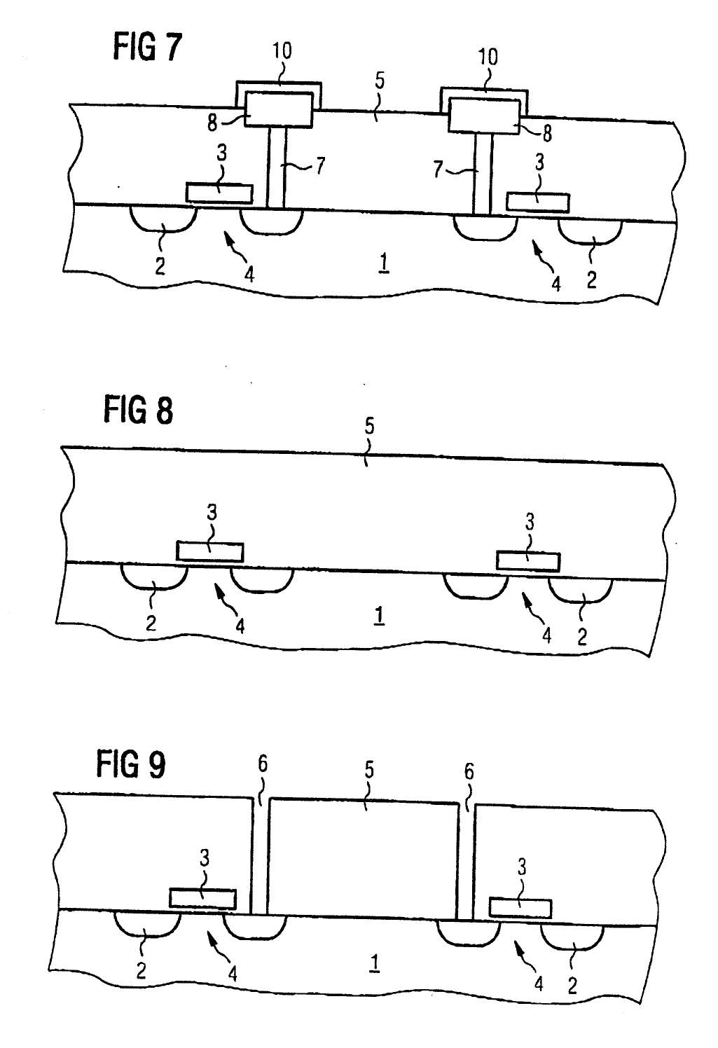

FIGS. 6 and 7 show a second method according to the invention for the fabrication of a patterned layer.

The first steps of this further embodiment of the present inventions correspond to the steps that have been explained in connection with FIGS. 1 to 4. Therefore, these steps are not explained again. Starting from the situation shown in FIG. 4, etchback of the insulating layer 5 that is selective with respect to the barrier 8 then takes place, resulting in the situation shown in FIG. 6.

As a result, the first step a) of the method according to the invention is concluded. A substrate having connection regions, the barriers 8, and a migration region, the insulating layer 5, has been provided.

Once again, this is followed by the selective deposition of the electrode material. For this purpose, the volatile organometallic compound CpPt(Me)₃ in gaseous form is passed onto the prestructured substrate at a pressure of 10⁻² bar and a temperature of 70° C. The catalytic action of the iridium oxide in the connection regions causes the organometallic compound CpPt(Me)₃ to decompose at the surface of the connection regions, where platinum is deposited. Because the surface of the insulating layer 5 is catalytically inactive with regard to the organometallic compound CpPt(Me)₃, there is no decomposition of the organometallic compound CpPt(Me)₃ at the surface of the insulation region under the cited conditions (pressure and temperature), so that no platinum is deposited on the insulation region. The resulting situation is shown in FIG. 7.

The embodiment shown in FIG. 7 has the advantage that the side walls of the barrier 8 can also be used at least in part as capacitor surfaces, with the result that the capacitor surface area is increased for substantially the same lateral extent of the capacitor.

FIGS. 8 to 12 show a third method according to the invention for fabricating a patterned layer.

FIG. 8 once again shows a silicon substrate 1 with select transistors 4 that have already been produced. The select transistors 4 each have two diffusion regions 2 that are disposed at the surface of the silicon substrate 1. The channel zone, which is separated from the gate electrode 3 on the surface of the silicon substrate 1 by the gate oxide, is disposed between the diffusion regions 2 of a select transistor 4. These select transistors are fabricated using the methods that are known in the prior art and will not be explained in more detail in the present description. An insulating layer 5, for example an SiO₂ layer, is applied to the silicon substrate having the select transistors 4. Depending on the method used for the fabrication of the select transistors 4, it is also possible for a plurality of insulating layers to be applied.

Then, a photographic technique is used to produce the contact holes 6. This is achieved, for example, by anisotropic etching using fluorine-containing gases. The resulting structure is shown in FIG. 9.

A conductive material 7, for example polysilicon doped in situ, is then applied to the structure. This can be achieved, for example, by a CVD method. The application of the conductive material 7 causes the contact holes 6 to be filled up completely, and a cohesive conductive layer is formed on the top side of the silicon substrate 1. A CMP (Chemical Mechanical Polishing) step then follows, which removes the cohesive conductive layer at the top side of the silicon substrate 1 and produces a planar surface.

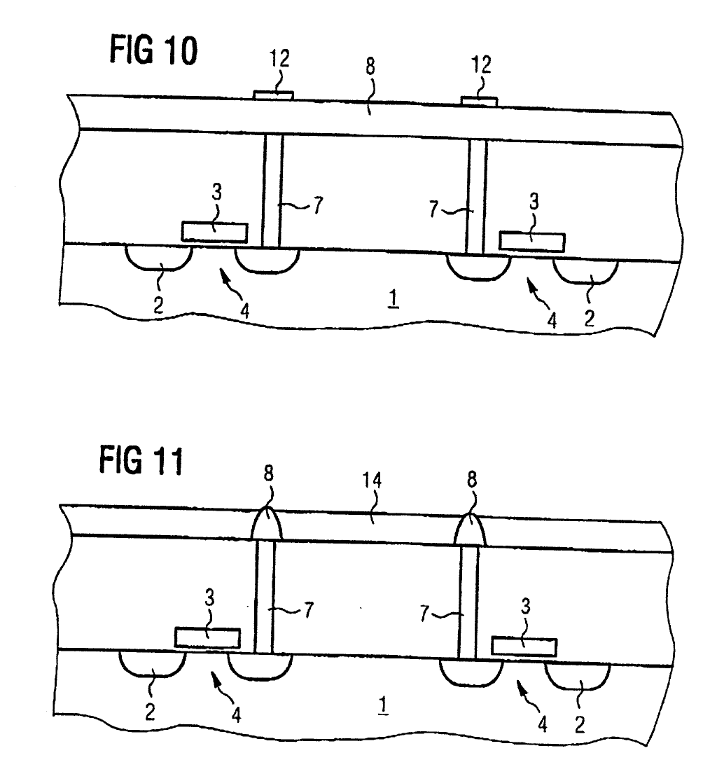

Next, the barrier material 8, for example iridiumoxide, is deposited over the entire surface and a TiN hard mask 12 is produced on the barrier layer 8 for the purpose of patterning of the barrier layer 8. The resulting structure is shown in FIG. 10.

The use of the TiN hard mask 12 results in rounded edges during the patterning of the barrier layer 8. Consequently, the structures produced in this way have a smaller lateral extent on their top side than on their underside. Then, a further SiO₂ layer 14 is deposited and a CMP step is carried out. In this way, the region around the barriers 8 is filled with silicon oxide, and barriers 8 with a lateral extent that is smaller than could be produced directly with the lithography method employed, are formed at the surface. The resulting structure is shown in FIG. 11.

The first step a) of the method according to the invention is then concluded. A substrate having catalytically active connection regions, the barriers 8, and a catalytically inactive insulation region, the insulating layer 14, has been provided.

There then follows the selective deposition of the electrode material, for example platinum. For this purpose, Pt(PF₃)₄ (tetrakis(trifluorophosphane)platinum) in gaseous form is passed onto the prestructured substrate at a pressure of 10⁻² bar and a temperature of 110° C. The catalytic action of the iridium oxide in the connection regions causes Pt(PF₃)₄ to decompose at the surface of the connection regions, where platinum is deposited. Because the surface of the insulating layer 14 is catalytically inactive with respect to Pt(PF₃)₄, there is no decomposition of Pt(PF₃)₄ at the surface of the insulation region under the cited conditions (pressure and temperature), so that no platinum is deposited on the insulation region.

The platinum that has been selectively deposited in this way grows epitaxially and substantially in monocrystalline form. This has the advantage that during the production of the dielectric or ferroelectric layer that is subsequently completed, diffusion of oxygen atoms or, for example, bismuth atoms through the electrode 10 to the barrier 8 can be avoided. Diffusion of this type generally takes place along grain boundaries that are present substantially only at the edge of the crystal due to the monocrystalline growth of the electrode 10.

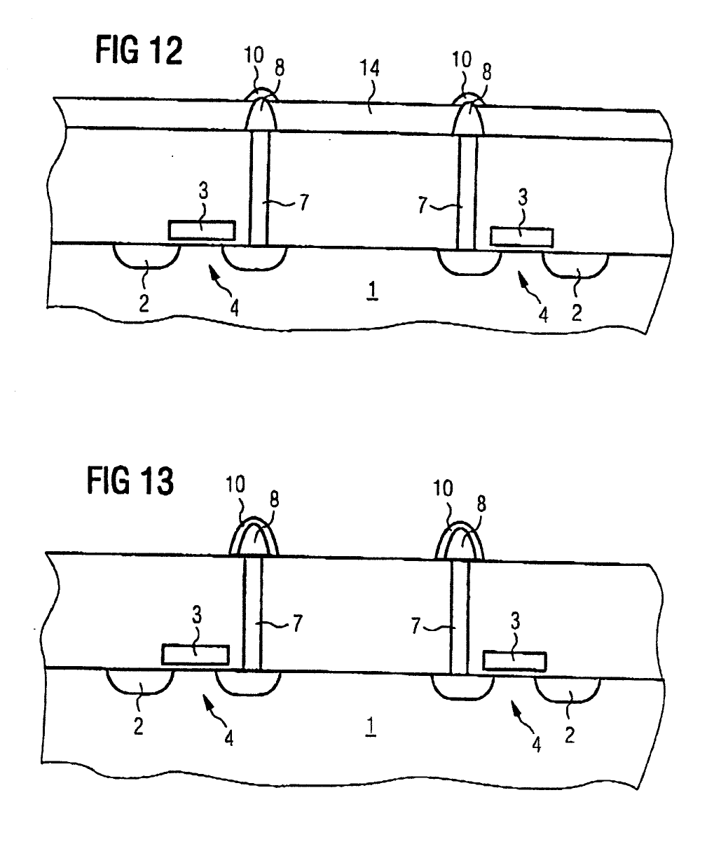

The selective deposition of platinum on the barriers 8 produces self-aligned platinum structures with a lateral dimension of less than 0.1 mm without the need for an additional etching step. The resulting structure is shown in FIG. 12.

Once again, there follows the production of a dielectric and/or ferroelectric layer and the deposition of a further layer in order to form the upper electrode (not shown). These layers are usually then patterned together, so that the memory cells including a select transistor 4 and a capacitor are completed.

According to a further embodiment of the present invention, the deposition of the further SiO₂ layer 14 shown in FIG. 11 can be dispensed with. The result is a configuration that is similar to the situation shown in FIG. 6. The configuration shown in FIG. 13 can then be achieved by selective platinum deposition steps that have already been explained.

The embodiment shown in FIG. 13 has the advantage that the side walls of the barrier 8 can also be used as capacitor surfaces, resulting in an increase in the capacitor surface area for substantially the same lateral extent of the capacitor.

We claim:

1. A method for fabricating a precious-metal electrode for a storage capacitor, which comprises:
providing a substrate;
applying a catalytically inactive insulation to the substrate;
applying a catalytically active connection region to the substrate, the catalytically active connection region being a precious metal material selected from the group consisting of a precious metal and an oxide of a precious metal;
producing the catalytically active connection region and the catalytically inactive insulation region; and
depositing selectively the precious metal material on the catalytically active connection region by passing an organometallic compound of a precious metal to the substrate at a temperature from 0° to 120° C.

2. The method according to claim 1, wherein the step of producing of the catalytically active connection region and the catalytically inactive insulation region includes patterning the connection region.

3. The method according to claim 1, wherein the step of producing the catalytically active connection region and the catalytically inactive insulation region includes planarizing the connection region and the insulation region.

4. The method according to claim 1, wherein the temperature is from 20° to 80° C. during the step of depositing selectively the precious metal material on the catalytically active connection region by passing the organometallic compound of the precious metal material to the substrate.

5. The method according to claim 4, wherein the temperature is from 40° to 70° C. during the step of depositing selectively the precious metal material on the catalytically active connection region by passing the organometallic compound of the precious metal material to the substrate.

6. The method according to claim 1, which further comprises choosing the organometallic compound of a precious metal from the group consisting of Pt(CO)₂Cl₂, Cp*PtMe₂, and CpPtMe₃.

7. The method according to claim 1, which further comprises using a reducing agent while depositing selectively the precious metal material on the catalytically active connection region.

8. The method according to claim 7, which further comprises using hydrogen (H₂) as the reducing agent.

9. The method according to claim 1, which further comprises pressurizing from 10⁻⁴ to 10 bar during the depositing selectively of the precious metal material on the catalytically active connection region.

10. The method according to claim 9, which further comprises pressuring from 10⁻³ to 10⁻¹ bar during the depositing selectively of the precious metal material on the catalytically active connection region.

11. The method according to claim 1, which further comprises selecting the catalytically inactive insulation region from the group consisting of SiO₂, Si₃N₄, Al₂O₃, AlN, BN, MgO, La₂O₃, LaN, Y₂O₃, YN, Sc₂O₃, ScN, TiO₂, Ta₂O₃, and oxides of lanthanides.

12. The method according to claim 1, which further comprises including in the catalytically active connection region elements selected from the group consisting of rhodium, iridium, ruthenium, osmium, and rhenium.

13. The method according to claim 1, which further comprises including in the catalytically active connection region oxides of elements selected from the group consisting of rhodium, iridium, ruthenium, osmium, and rhenium.

14. The method according to claim 1, which further comprises selecting the precious metal for the precious-metal electrode from the group consisting of platinum, palladium, rhodium, iridium, ruthenium, osmium, and rhenium.

15. The method according to claim 1, which further comprises depositing the connection region as a layer.

16. The method according to claim 2, which further comprises patterning the connection region using a hard mask.

17. The method according to claim 1, which further comprises depositing the insulation region as a layer.

18. The method according to claim 3, wherein the planarizing step includes a CMP step.

19. A method for fabricating a precious-metal electrode for a storage capacitor, which comprises:
providing a substrate;
applying a catalytically active connection region to the substrate, the catalytically active connection region being a precious metal material selected from the group consisting of a precious metal and an oxide of a precious metal;
applying a catalytically inactive insulation region to the substrate;
producing a catalytically active connection region and a catalytically inactive insulation region; and
depositing selectively the precious metal material on the catalytically active connection region by passing Pt(PF₃)₄ to the substrate at a temperature of from 80° to 150° C.

20. The method according to claim 19, wherein the step of producing the catalytically active connection region and the catalytically inactive insulation region includes patterning the connection region.

21. The method according to claim 19, wherein the step of producing the catalytically active connection region and the catalytically inactive insulation region includes planarizing the connection region and the insulation region.

22. The method according to claim 19, wherein the step of depositing selectively the precious metal material on the catalytically active connection region is conducted at a temperature from 100° to 120° C.

23. The method according to claim 19, which further comprises using a reducing agent while depositing selectively the precious metal material on the catalytically active connection region.

24. The method according to claim 23, which further comprises using hydrogen (H₂) as the reducing agent.

25. The method according to claim 19, which further comprises pressurizing from 10⁻⁴ to 10 bar during the step of depositing selectively the precious metal material on the catalytically active connection region.

26. The method according to claim 25, which further comprises pressuring from 10⁻³ to 10⁻¹ bar during the step of depositing selectively the precious metal material on the catalytically active connection region.

27. The method according to claim 19, which further comprises selecting the catalytically inactive insulation region from the group consisting of SiO₂, Si₃N₄, Al₂O₃, AlN, BN, MgO, La₂O₃, LaN, Y₂O₃, YN, Sc₂O₃, ScN, TiO₂, Ta₂O₃, and oxides of lanthanides.

28. The method according to claim 19, which further comprises including in the catalytically active connection region elements selected from the group consisting of rhodium, iridium, ruthenium, osmium, and rhenium.

29. The method according to claim 19, which further comprises including in the catalytically active connection region oxides of elements selected from the group consisting of rhodium, iridium, ruthenium, osmium, and rhenium.

30. The method according to claim 19, which further comprises selecting the precious metal for the precious-metal electrode from the group consisting of platinum, palladium, rhodium, iridium, ruthenium, osmium, and rhenium.

31. The method according to claim 19, which further comprises depositing the connection region as a layer.

32. The method according to claim 20, which further comprises patterning the connection region using a hard mask.

33. The method according to claim 19, which further comprises depositing the insulation region as a layer.

34. The method according to claim 21, wherein the planarizing step includes a CMP step.
